(19) United States
(12) Patent Application Publication
(10) Pub. No.: US 2009/0237187 A1
(43) Pub. Date: Sep. 24, 2009

(54) Auxiliary release for a circuit breaker

(76) Inventor: Daniel Gawendowicz, Falkensee (DE)

Correspondence Address: HARNESS, DICKEY & PIERCE, P.L.C., P.O.BOX 8910, RESTON, VA, 20195, US

(21) Appl. No.: 12/311,126

(22) PCT Filed: Sep. 21, 2006
(86) PCT No.: PCT/DE2006/001685

§ 371 Date: Mar. 19, 2009

(51) Int. Cl. H01H 83/12

(52) U.S. Cl. 335/20

(57) ABSTRACT

At least one embodiment of the invention relates to an auxiliary release for a circuit breaker. The auxiliary release includes an undervoltage release for mechanically actuating an actuating element, and a connection point for connecting a voltage release is arranged in the circuit of the undervoltage release.

### PRIORITY STATEMENT

This application is the national phase under 35 U.S.C. § 371 of PCT International Application No. PCT/DE2006/001685 which has an International filing date of Sep. 21, 2006, which designated the United States of America, the entire contents of each of which are hereby incorporated herein by reference.

### FIELD

At least one embodiment of the invention generally relates to an auxiliary release for a circuit breaker. In at least one embodiment, the auxiliary release can be used, for example, as an accessory for a compact low-voltage circuit breaker.

### BACKGROUND

Modern circuit breakers are subject to the requirement that they combine the functions of a voltage release and an undervoltage release in one unit, for example in a compact low-voltage circuit breaker. An undervoltage release switches off when no voltage or a voltage below a defined value is applied to it. As a result, uncontrolled restarting operations of machines, for example after a power failure, can be prevented.

A voltage release switches off when a voltage is applied to it which exceeds a specific value.

The circuit breaker equipped with an undervoltage release and a voltage release is intended to have an extremely compact design, as far as possible. In this case, the enveloping dimensions of individual circuit breaker types are sometimes already fixed, and it is necessary for further auxiliary and alarm switches to be integrated in such circuit breakers. In addition, there is a conflict in terms of aims between the requirement for a control current which is only low and at the same time a high level of reliability of the resultant switching state of the circuit breaker, i.e. it is necessary for low control currents to be used to generate such a mechanical movement of the switching elements of the circuit breaker that said circuit breaker reliably reaches the desired switching state and maintains said switching state in stable fashion.

It is known to implement the mentioned functions by incorporating a voltage release and an undervoltage release as two internal accessories in the circuit breaker. Both accessories in this case each have a dedicated mechanical coupling point to the actuating element for the circuit breaker, i.e. there are two transfer points between the respective release and the mechanical actuating element given a conventional design of the circuit breaker equipped with a voltage release and an undervoltage release.

### SUMMARY

At least one embodiment of the invention provides an auxiliary release which makes it possible, with a simple and inexpensive design, to combine the function of an undervoltage release and the function of a voltage release in one unit with small enveloping dimensions given a low energy requirement and a high degree of tripping reliability.

An auxiliary release for a circuit breaker is provided in at least one embodiment, the auxiliary release comprising an undervoltage release for mechanically actuating an actuating element, and a connection point for connecting a voltage release is arranged in the circuit of the undervoltage release.

The undervoltage release may have a coil, which exerts a force on an actuator in the state in which a current is flowing through the coil. The circuit, in which the voltage release can be integrated, is therefore the circuit in which the coil of the undervoltage release is arranged. The movement of the actuator on or in the coil is transmitted mechanically to the actuating element. In this case, the actuating element is, for example, a mechanical switching mechanism of a circuit breaker, which trips or switches the circuit breaker, i.e. brings the contacts of the circuit breaker into the open position.

The fact that it is possible for the voltage release to be integrated in the circuit of the undervoltage release provides flexibility of the auxiliary release to the extent that it can be used in an embodiment without a voltage release and in a different embodiment with an integrated voltage release. That is to say that the auxiliary release according to at least one embodiment of the invention can, if necessary, be retrofitted with a voltage release.

In an advantageous configuration of at least one embodiment, the auxiliary release furthermore comprises a voltage release, which is connected to the connection point in the circuit of the undervoltage release and which causes the circuit to be interrupted when a specific voltage applied to it is exceeded.

That is to say that a voltage release and an undervoltage release are combined in an accessory for a circuit breaker. In this case, the voltage release is actuated by an external current pulse. The voltage release and the undervoltage release define different, mutually independent control voltage ranges, in which the circuit breaker is intended to remain closed or is intended to be tripped/switched off.

Volume is saved in the interior of the circuit breaker by virtue of the fact that only one module is used, in which the functions of the voltage release and the undervoltage release are combined. The simple option for the manufacture of the module performing both functions saves on manufacturing costs. At the same time, the reliability of the circuit is increased since there is only one interface between the auxiliary release and the mechanical tripping shaft of the actuating element.

Furthermore, material costs are saved since, despite the fact that two tripping functions are performed in an auxiliary release, only a tripping coil, an actuator and a transmission mechanism for transmitting the switching movement triggered by the undervoltage release to the circuit breaker are provided.

In addition, there is a low energy requirement for the tripping of the voltage release since the opening function thereof can already be realized by semiconductor components or else by very small coils.

The use of the auxiliary release according to at least one embodiment of the invention is not restricted to compact low-voltage circuit breakers (MCCBs—molded case circuit breakers), but can also be used in the case of circuit breakers of different size and power such as in the case of open circuit breakers (ACB—air circuit breakers), for example.

In a configuration of the arrangement of the voltage release in the circuit of the undervoltage release, it is provided that the voltage release is connected undetachably to the connection point in the circuit. That is to say that the auxiliary release according to at least one embodiment of the invention has been produced with an integrated voltage release.

In an alternative configuration, it is provided in this regard that a voltage release configured as a module is connected detachably to the connection point in the circuit of the undervoltage release. As a result of the fact that it is possible for a modular voltage release to be subsequently retrofitted, production costs can be reduced and the flexibility of the undervoltage release can be increased.

However, it can also be provided that a voltage release with a modular design can be fixedly connected to the connection point.

A further advantageous configuration provides that the voltage release comprises a semiconductor component as the component interrupting the circuit. In this design configuration, there is therefore only one coil in the auxiliary release according to at least one embodiment of the invention, namely the coil of the undervoltage release. That is to say that only one coil consumes energy despite the fact that two release functions are combined.

An alternative configuration for the arrangement of a semiconductor component provides that the voltage release comprises a relay as the component interrupting the circuit.

This embodiment has the advantage that the contacts of the circuit of the undervoltage release are DC-isolated. Although a further coil is in this case arranged next to the coil of the undervoltage release in the relay, this further coil can be dimensioned in such a way that it ensures the opening function of the circuit of the undervoltage release with a low current consumption as well.

Advantageously, the tripping voltage of the relay is adjustable. It is thus possible to adjust the value at which the voltage release interrupts the circuit of the undervoltage release and said undervoltage release in turn actuates an actuating element by means of its actuator, which actuating element causes the circuit breaker to open.

Furthermore, a particular configuration provides that the voltage release trips at a voltage which is at least 55% of the rated voltage. With this configuration, the voltage release satisfies more stringent requirements which are set in specific branches of the economy.

A further design configuration of the auxiliary release according to the invention provides that the auxiliary release furthermore comprises a switching element and a voltage release, which is mechanically coupled to this switching element, the switching element being connected to the connection point in this circuit, and the voltage release causing the circuit to be interrupted when a specific voltage applied to it is exceeded. In this configuration, the voltage release does not itself open the circuit of the undervoltage release, but instead it actuates a switching element, which is preferably a normally-closed contact, and this switching element opens the circuit.

### BRIEF DESCRIPTION OF THE DRAWINGS

Embodiments of he invention will be described with reference to the attached drawing, in which:

FIG. 1 shows a schematic illustration of the auxiliary release according to an embodiment of the invention, which is coupled to a circuit breaker via a mechanical actuating element.

### DETAILED DESCRIPTION OF THE EXAMPLE EMBODIMENTS

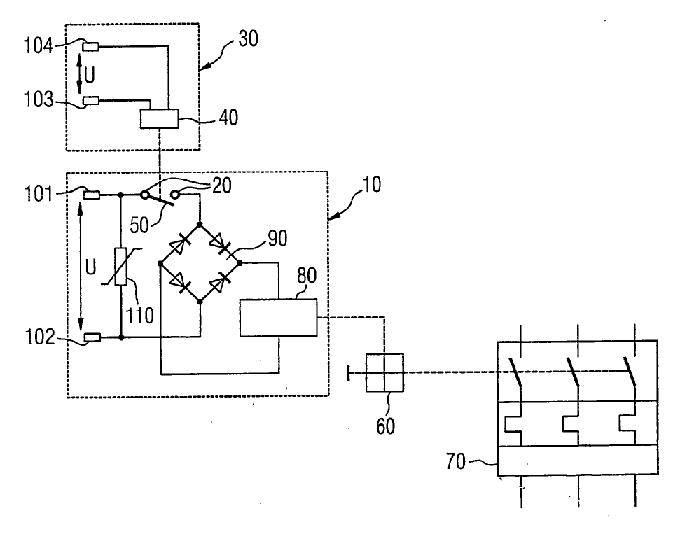

The embodiment of the auxiliary release illustrated in FIG. 1 substantially comprises the undervoltage release 10, indicated in a respective box and the voltage release 30 arranged next to it. The voltage release 30 is arranged next to the undervoltage release 10 via the connection point 20 in the circuit of said undervoltage release 10. In the embodiment illustrated, the voltage release 30 comprises a relay 40, which acts on a switching element 50 arranged at the connection point 20.

The undervoltage release 10 comprises a coil 80, which exerts a force on an actuator (not illustrated), whose movement is transmitted to a mechanical actuating element 60. This mechanical actuating element 60 transmits a mechanical movement to a circuit breaker 70. Furthermore, a variable resistor 110 is arranged in the undervoltage release 10 between the first connection terminal 101 and the second connection terminal 102.

If the voltage applied at the first undervoltage release at the first connection terminal 101 and second connection terminal 102 thereof falls below a defined value, a current, which correspondingly flows via a rectifier bridge 90, in the coil 80 causes an actuator to move. The movement of the actuator, as described, is transmitted to the contacts of the circuit breaker 70 via the mechanical actuating element 60, with the result that the contacts of said circuit breaker 70 are opened. Thus, in the event of a voltage interruption, for example in the event of an accident, the circuit breaker can be switched off or tripped. This device has the advantage that when the voltage is applied again, the circuit breaker continues to remain open, with the result that uncontrolled startup of a machine is prevented.

If a voltage is applied to the third connection terminal 103 and the fourth connection terminal 104 which exceeds a specific tripping voltage of the voltage release 30, the relay 40 of the voltage release 30 is actuated, and the movement thereof is transmitted to the switching element 50 arranged in the circuit of the undervoltage release 10. The switching element 50 thus opens the circuit of the undervoltage release 10. This results in a movement, as already described above, of the actuator at the coil 80 of the undervoltage release 10 to the extent that the contacts of the circuit breaker 70 are opened via the mechanical actuating element 60. This configuration thus makes it possible for the circuit breaker 70 to be switched off or tripped if an excessively high voltage is applied, for example, in the overall energy system of the circuit breaker 70.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. An auxiliary release for a circuit breaker, comprising:
an undervoltage release to mechanically actuate an actuating element, a connection point for connecting a voltage release being arranged in a circuit of the undervoltage release.

2. The auxiliary release as claimed in claim 1, further comprising a voltage release, connected to the connection point in the circuit of the undervoltage release, to cause the circuit to be interrupted when a specific voltage applied to the circuit is exceeded.

3. The auxiliary release as claimed in claim 2, wherein the voltage release is undetachably connected to the connection point in the circuit of the undervoltage release.

4. The auxiliary release as claimed in claim 2, wherein the voltage release, configured as a module, is detachably connected to the connection point in the circuit of the undervoltage release.

5. The auxiliary release as claimed in claim 2, wherein the voltage release comprises a semiconductor component as the component interrupting the circuit.

6. The auxiliary release as claimed in claim 2, wherein the voltage release comprises a relay as the component interrupting the circuit.

7. The auxiliary release as claimed in claim 6, wherein the tripping voltage of the relay is adjustable.

8. The auxiliary release as claimed in claim 2, wherein the voltage release trips at a voltage which is at least 55% of the rated voltage.

9. The auxiliary release as claimed in claim 1, further comprising:
a switching element connected to the connection point in the circuit; and
a voltage release, mechanically coupled to the switching element, the voltage release causing the circuit to be interrupted when a specific voltage applied to the voltage release is exceeded.

10. The auxiliary release as claimed in claim 3, wherein the voltage release comprises a semiconductor component as the component interrupting the circuit.

11. The auxiliary release as claimed in claim 3, wherein the voltage release comprises a relay as the component interrupting the circuit.

12. The auxiliary release as claimed in claim 4, wherein the voltage release comprises a semiconductor component as the component interrupting the circuit.

13. The auxiliary release as claimed in claim 4, wherein the voltage release comprises a relay as the component interrupting the circuit.

14. The auxiliary release as claimed in claim 11, wherein the tripping voltage of the relay is adjustable.

15. The auxiliary release as claimed in claim 13, wherein the tripping voltage of the relay is adjustable.

16. The auxiliary release as claimed in claim 2, wherein the specific voltage is at least 55% of the rated voltage.

17. The auxiliary release as claimed in claim 9, wherein the specific voltage is at least 55% of the rated voltage.

18. An accessory for a circuit breaker, comprising:
an undervoltage release to mechanically actuate an actuating element, a connection point for connecting a voltage release being arranged in a circuit of the undervoltage release; and
a voltage release, connected to the connection point in the circuit of the undervoltage release, to cause the circuit to be interrupted when a specific voltage applied to the circuit is exceeded.

19. The auxiliary release as claimed in claim 18, wherein the specific voltage is at least 55% of the rated voltage.
